(19) United States
(12) Patent Application Publication
(10) Pub. No.: US 2002/0001656 A1
(43) Pub. Date: Jan. 3, 2002

(54) DRY MIX FOR A LOW-CALORIE SLUSH

(76) Inventors: CHARLES R. MASON, MAHOPAC, NY (US); WALTER L. SCHMIDT, HOPEWELL JUNCTION, NY (US); RITA W. BRANDER, NEW ROCHELLE, NY (US); AUDRA L. LANDON, SLEEPY HOLLOW, NY (US)

Correspondence Address: KRAFT FOODS INC, 555 SOUTH BROADWAY, TARRYTOWN, NY, 10591

(21) Appl. No.: 09/323,977

(22) Filed: Jun. 2, 1999

(51) Int. Cl. A23L 2/00; A23L 2/40

(52) U.S. Cl. 426/565; 426/591; 426/590; 426/573

(57) ABSTRACT

A dry mix for producing a low-calorie slush when combined with an aqueous fluid and ice in an electric blender. The dry mix contains 62-87% bulking agent, such as maltodextrin, 2-20% food acid, 3-15% low-viscosity hydrocolloid, 1-8% non-gelling hydrocolloid, one or more intensive sweeteners and optionally a carbonating salt. Preferably, the mix is sugar-free and produces a slush, when combined with water and ice, having a calorie content of less than 60 calories per 8-ounce serving.

### FIELD OF THE INVENTION

Soft-frozen slush products containing ice crystals have attained wide consumer acceptance. Commercial methods and equipment have been developed to produce and dispense slush products for consumption at or near the place of sale. These slush products are composed of ice crystals distributed throughout a sweetened and flavored aqueous matrix and typically have both a refreshing and cooling effect and good eye appeal.

The disadvantages of commercial slush products include their need for constant mechanical agitation in order to prevent agglomeration of the ice crystals prior to sale and the inability to obtain the slush product outside of the commercial setting (e.g., convenience stores). These products have also been found to contain relatively coarse ice crystals and usually these products are not sufficiently fluid that they can be consumed through as a beverage.

Consequently, there has existed a need for products which can be conveniently converted to a slush in the home. Such a slush should be composed of a large quantity of small ice crystals. The ice crystals should be sufficiently small that the slush has a smooth texture and can be consumed at a temperature of about −3.9° C. (25° F.).

### DESCRIPTION OF THE PRIOR ART

Prior art exists, such as U.S. Pat. No. 3,826,829, to Marulich, hereby incorporated by reference, describing a liquid which can be consumed as a ready-to-drink beverage or which can be transformed into a slush by placing the liquid in a home freezer. This patent, and other similar prior art disclosures, include within the formulation ingredients, such as ethyl alcohol and/or polyphydric alcohols (e.g., glycerol), which could be seen as either incompatible with products designed for children and/or known to impart an undesirable taste. These low-molecular weight alcohol's, as well as other known freezing point depressants, also prolong the time needed to obtain a slush.

Dry mixes for producing a slush-beverage in the home have been disclosed in U.S. Pat. No. 5,853,785, to Nayyar et al. which is also incorporated by reference. According to this patent, the dry mix is dissolved in water and then stored in the freezer for over two hours to obtain a slush consistency.

In both the Marilich and Nayyar et al. inventions, a relatively high-solids and typically high sugar, liquid is placed in a home freezer for an extended period of time in order to obtain a desirable slush consistency. It would be desirable to provide a product which could be used to quickly prepare a slush product in a home environment and particularly desirable if the prepared slush was a low-calorie foodstuff, such as having a calorie count of no more than 60 calories, preferably no more than 40 calories, per 8-ounce (237 ml) serving.

### SUMMARY OF THE INVENTION

The dry mixes of this invention are formulated to be combined with water and ice to quickly produce a low-calorie, preferably sugar-free, slush in an electric home blender. It would, of course, be possible to substitute an alcoholic beverage, such as vodka or rum, for the water component to produce an alcoholic slush for adult consumption having a somewhat higher calorie count. Other aqueous fluids such as a fruit juice or carbonated water might also be used.

A unique combination of functional ingredients are combined to produce the dry mix of this invention. These ingredients function together to produce a product which:

(1) is easy to use for blender preparation of a slush without freeze-up;

(2) develops a fruit-like texture, viscosity and mouthfeel;

(3) can product slushes of varying texture with minor recipe modifications of the water to ice ratio;

(4) takes only a few minutes to prepare a slush; and

(5) can deliver a slush having less than about 40 calories per eight-ounce serving.

The dry ingredients for the practice of this invention include a water-soluble, bulking agent, such as a maltodextrin, food acid, such as citric acid, low-viscosity hydrocolloid, such as hydrolyzed guar gum, a macromolecular, non-gelling hydrocolloid, such as xanthan gum, and intensive sweetener. Preferably the dry mix will also contain a carbonating agent, such as sodium bicarbonate.

The other functional ingredients such as flavor and color agents, flow agents, buffer agents, and cloud agents, all of which are well-known in the field of powdered drink mixes, may be included in the mix.

All percentages recited in the description and claims of this invention are weight percents.

### DESCRIPTION OF PREFERRED EMBODIMENTS

The water-soluble, bulking agent although preferably a carbohydrate, such as a maltodextrin having a dextrose equivalent (D.E.) of 15 or below, could be any water-soluble sugar or non-sugar carbohydrate or sugar alcohol which is capable of providing solids and body without imparting an off-flavor, thus polydextrose, polyglucose, xylitol, mannitol, sorbitol, inulin, hydrogenated starch hydrolyzates and the like, alone or in combination could prove useful as the bulking agent. These bulking agents can be employed as a spray-dried powder or in agglomerated form if increased dispersibility is desired. A range for the bulking agent of 62-87%, preferably 65-85%, by weight of the dry mix is suitable for use in this invention.

The food acid is preferably citric acid; however, other acidulants, such as malic acid, tartaric acid, adipic acid, fumaric acid or mixtures of these acids, may also be useful. In addition to providing the desired acidity to the product, the food acid is also useful to aid in dispensing other ingredients. For this purpose, the food acid should be in fine granular form such that at least 40% by weight of the acid, preferably at least 50% by weight, is retained on a No. 60 U.S. mesh sieve (openings 250 microns) and no more than 5% by weight, preferably no more than 2.5% by weight, passes through a No. 100 U.S. mesh sieve (openings 149 microns). A range for the food acid of 2-20%, preferably 3-15%, by weight of the dry mix is suitable for use in this invention.

The preferred water-soluble, low-viscosity hydrocolloid is partially-hydrolyzed guar gum having a soluble dietary fiber content of at least 80% by weight (AOAC method). Preferably the material is in the form of an agglomerated powder such as the commercially-available ingredient known as agglomerated Benefiber®, a product of Sandoz Nutrition Corporation, Minneapolis, Minn. 55416. The agglomerated powder should have a particle size wherein a maximum of 50% by weight, preferably 15-40% by weight, passes through a No. 80 U.S. mesh sieve (177 microns). Other water-soluble, partially-hydrolyzed polysaccharides could function similarly in this invention. An example would be the enzyme-degraded cellulose derivatives described in U.S. Pat. No.5,366,755. By low-viscosity is meant that a 2% solution (at 20° C.) of the hydrocolloid will have a viscosity of less than 50 mPas, preferably less than 25 mPas and most preferably less than 10 mPas. Typically, these materials will have a molecular weight of less than 15,000 Daltons and preferably fall within the range of 1,000 to 10,000 Daltons. A range for the low-viscosity hydrocolloid of 3-15%, preferably 4-10%, by weight of the dry mix is suitable for use in this invention.

The preferred non-gelling hydrocolloid is xanthan gum. Other non-gelling hydrocolloids, such as pectin, guar gum and starches, have been found to be less preferred than xanthan gum. A range for the non-gelling hydrocolloid of 1-8%, preferably 2-5%, by weight of the dry mix is suitable for use in this invention.

Preferably, the dry mix formulation also contains a carbonating salt which will generate and release carbon dioxide as the mix comes in contact with water. These salts are well-known in the art and may be used singly or in combination. The released carbon dioxide develops a slight foam within the slush product and improves the texture of the slush. The level of salts should not be so great as to provide an adverse flavor impact. Carbonate and bicarbonate salts are preferred with sodium bicarbonate being the most preferred material. As will be apparent to those skilled in the art, an acid component is needed to effect release of carbon dioxide, and the acid thus consumed, will not be available for pH effect. A desirable level for carbonating salts is 0.3 to 2%, preferably 0.4-1.5% by weight of the dry mix.

The intensive sweetener employed in the mix may be any one or a combination of the well-known materials availble for use in foods in accordance with applicable governmental regulation. Among these materials would be saccharin, cyclamates, acetosulfame, L-aspartyl-based sweeteners, such as aspartame, alitame and trichloro sucrose. A preferred sweetener is a combination of aspartame and acetosulfam-K.

For preparing the slush, the dry mix is added to a blender followed by water (or other aqueous fluid) and then ice. The weight ratio of water to ice will be 1:0.9-1.5. Lower amounts of ice will produce a more fluid slush which might be characterized as a frosty drink while larger amounts of ice will produce a slush having a spoonable consistency. Typically, the level of dry mix contained in the slush mixture will result in a solids level of 3-9% by weight, more typically 4-6% by weight.

The blender is covered and the dry mix, water and ice is blended for about 10 seconds at high speed. Then the contents are mixed with a spoon or like utensil, covered and blended again for about 5 seconds. The mixing blending sequence may be repeated until the desired slush consistency is obtained. The slush may then be poured or spooned into glasses and served. The amount of mixing and blending done by the consumer will be, in part, determined by the type of ice added to the blender, such as crushed ice versus ice cubes.

This invention is further described but not limited by the follow specific embodiments.

### EXAMPLE

| INGREDIENT | PARTS BY WEIGHT | | |
|---|---|---|---|
| FORMULA | A | B | C |
| Maltodextrin (10 D.E.) | 72.96 | 80.38 | 75.88 |
| Agglomerated Benefiber ® | 6.25 | 6.25 | 6.25 |
| Fine Granular Citric Acid | 12.50 | 5.00 | 10.00 |
| Xanthan Gum | 3.25 | 3.25 | 3.25 |
| Sodium Bicarbonate | 0.62 | 0.62 | 0.64 |
| Tricalcium Phosphate (flow agent) | 0.38 | 0.38 | 0.38 |
| Trisodium Citrate (buffer) | 0.25 | 0.25 | 0.25 |
| Aspartame/Acetosulfan-K | 1.00 | 1.23 | 1.01 |
| Clouding Agent | 0.14 | 0.14 | 0.14 |
| Flavor/Color | 2.64 | 2.50 | 2.21 |

Formulas A, B, and C were each flavor variants and were flavored and colored for lime margarita, pina colada, and straberry daquiri, respectively. Forty grams of dry mix, 414 ml of water and 430 g (about 3 cupfuls) of ice cubes were added to a blender which was covered, blended at high speed for 10 seconds, stirred with a spoon, blended for an additional 5 seconds, and then stirred and blended again. The resulting slush had the consistency of a frosty drink, had a volume of about one quart (946 ml), and a solids level of 4.5% by weight. An 8-ounce (237 ml) serving of the slush contained about 40 calories.

Conforming to requirements of the patent statutes, the present invention has been described in terms of preferred embodiments and various modifications thereof. It is understood, however, that the further modifications may be made in the light of the description that has been made and that the scope of the protection provided is defined by the claimed subject matter that follows.

Having thus described the invention what is claimed is:

1. A dry, sugar-free mix adapted to produce an edible slush upon being blended with water and ice, said mix being comprised of:

| | |
|---|---|
| 62-87% | carbohydrate or sugar alcohol bulking agent |
| 2-20% | food acid |
| 3-15% | low-viscosity hydrocolloid |
| 1-8% | non-gelling hydrocolloid |

said mix further containing intensive sweetener, flavor agents and color agents.

2. The dry mix of claim 1 containing:

| | |
|---|---|
| 65-85% | carbohydrate or sugar alcohol bulking agent |
| 3-15% | food acid |
| 4-10% | low-viscosity hydrocolloid |
| 2-5% | non-gelling hydrocolloid |
| 0.3-2% | carbonating salt |

3. The dry mix of claim 1 containing:

| | |
|---|---|
| 65-85% | maltodextrin, having a D.E. 15 or less |
| 3-15% | citric acid |
| 4-10% | partially-hydrolyzed guar gum |
| 2-5% | xanthan gum |
| 0.4-1.5% | carbonating salt |

4. The dry mix of claim 1 wherein the low-viscosity hydrocolloid is a partially-hydrolyzed polysaccharide containing at least 80% soluble fiber.

5. The dry mix of claim 4 wherein the polysaccharide is guar gum.

6. The dry mix of claim 1 wherein the low-viscosity hydrocolloid has a particle size whereby a maximum of 50% by weight passes through a No. 80 U.S. mesh sieve.

7. The dry mix of claim 1 wherein the non-gelling hydrocolloid is xanthan gum.

8. The dry mix of claim 1 wherein the food acid is in fine granular form wherein at least 40% by weight is retained on a No. 60 U.S. mesh sieve and no more than 5% by weight passes through a No. 100 U.S. mesh sieve.

9. A method of making an edible slush comprising blending together in an electric blender the dry mix of claim 1, aqueous fluid and ice.

10. The method of claim 9 wherein the ice is in the form of ice cubes and the weight ratio of aqueous fluid to ice is 1:0.9-1.5.

11. A method of making an edible slush comprising blending together the dry mix of claim 3 water and ice at a weight ratio of 1:0.9-1.5, the amount of dry mix producing a slush having a solids level of 4-6% by weight.
